(19) United States
(12) Patent Application Publication
(10) Pub. No.: US 2018/0357611 A1
(43) Pub. Date: Dec. 13, 2018

(54) PROVIDING SUGGESTIONS FOR TASK COMPLETION THROUGH INTELLIGENT CANVAS

(71) Applicant: MICROSOFT TECHNOLOGY LICENSING, LLC, Redmond, WA (US)

(72) Inventor: Shahil SONI, Seattle, WA (US)

(73) Assignee: MICROSOFT TECHNOLOGY LICENSING, LLC, Redmond, WA (US)

(21) Appl. No.: 15/621,254

(22) Filed: Jun. 13, 2017

(51) Int. Cl. G06Q 10/10; G06N 5/04; H04W 4/02

(52) U.S. Cl. CPC G06Q 10/1097; H04W 88/02; H04W 4/028; G06N 5/04

(57) ABSTRACT

A person's days may be full of both personal and work related tasks that need to be completed. Often a person will create some sort of structure to manage their tasks, such as a to-do list or a task list, but then the person must actual take the time to complete them. Embodiments are directed to an intelligent canvas to provide suggestions for task completion, and then implement those suggestions in order to promptly complete the tasks. For example, content input may be received on the intelligent canvas, a context for the content input may be determined based on information associated with a user, a time, a location, and/or one or more active applications, an inference may be performed for a suggestion to complete a task associated with the content input based on the determined context and the content input, and the suggestion may be implemented to complete the task.

### BACKGROUND

Life can be extremely busy. Each day may be full of both personal and work related tasks that need to be completed. Often a person may create a structure to be able to manage the many tasks required to ensure their completion. For example, the person may create a to-do list or a task list. Creating such a structure may require the person to plan when the tasks should be completed, but then the person must actually take the time to complete them.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to implementation of an intelligent canvas to provide suggestions for task completion. For example, content input may be received on the intelligent canvas, a context for the input may be determined based on information associated with a user, a time, a location, and/or one or more, active applications, an inference may be performed for a suggestion to complete a task associated with the content input based on the determined context and the content input, and the suggestion may be implemented to complete the task.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A through 1C include display diagrams illustrating an example network environment where a system to implement an intelligent canvas to provide suggestions for task completion may be implemented;

FIG. 2 includes a display diagram illustrating conceptually an example set of actions and components for determining a context of received content input in order to perform an inference based on the determined context and the content input;

FIG. 3 includes a display diagram illustrating conceptually an example set of actions and components for implementing a suggestion to complete a task associated with content input yielded from an inference performed based on the content input and a context determined for the content input;

FIG. 4 includes a display diagram illustrating conceptually an example set of actions and components for providing suggestions for task completion;

FIGS. 5A through 5C include display diagrams illustrating an example user interface of a task management application configured to implement an intelligent canvas to provide suggestions for task completion;

FIG. 6 is a networked environment, where a system according to embodiments may be implemented;

FIG. 7 is a block diagram of an example computing device, which may be used to implement an intelligent canvas to provide suggestions for task completion; and

FIG. 8 illustrates a logic flow diagram of a method to implement an intelligent canvas to provide suggestions for task completion, arranged in accordance with at least some embodiments described herein.

### DETAILED DESCRIPTION

As briefly described above, embodiments are directed to implementation of an intelligent canvas to provide suggestions for task completion. For example, content input may be received on the intelligent canvas. The content input may be received as a keyboard input, a mouse input, a pen input, a touch input, an optical capture, a voice input, a gyroscopic input, and/or an eye-tracking input, for example. In some embodiments, natural language processing techniques may be employed upon receipt of the content input based on a format of the content input. For example, if the content input is received as a voice input, the speech may be converted to text through speech recognition. A context for the input may be determined based on information associated with a user, a time, a location, and/or one or more active applications, and an inference may be performed for a suggestion to complete a task associated with the content input based on the determined context and the content input. The suggestion may then be implemented to complete the task.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable, memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for implementing an intelligent canvas to provide suggestions for task completion. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

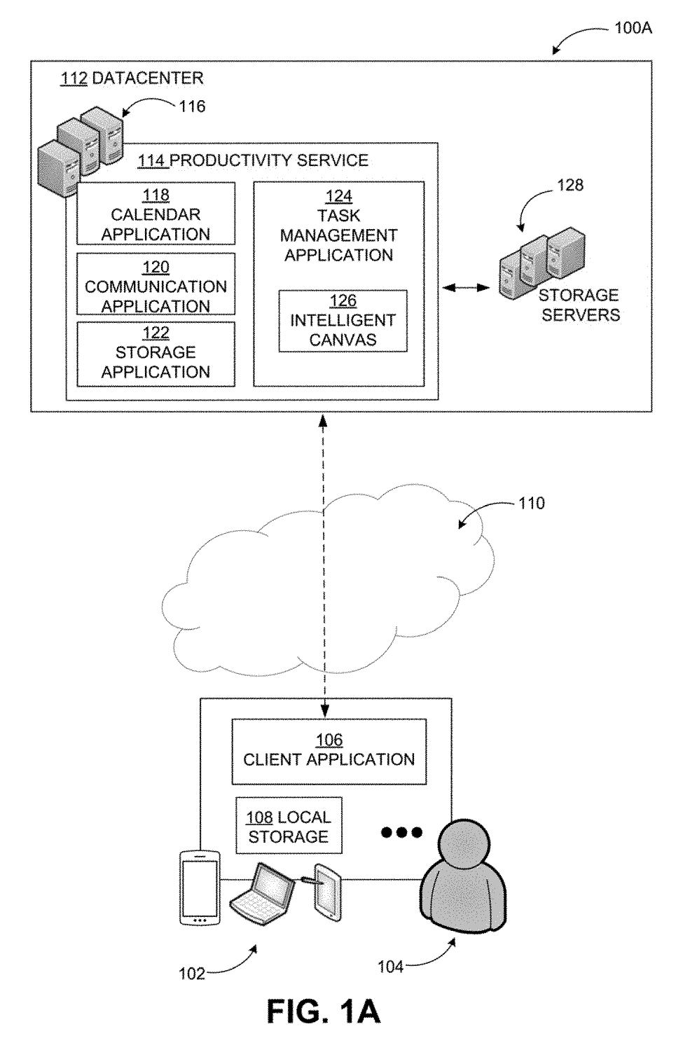

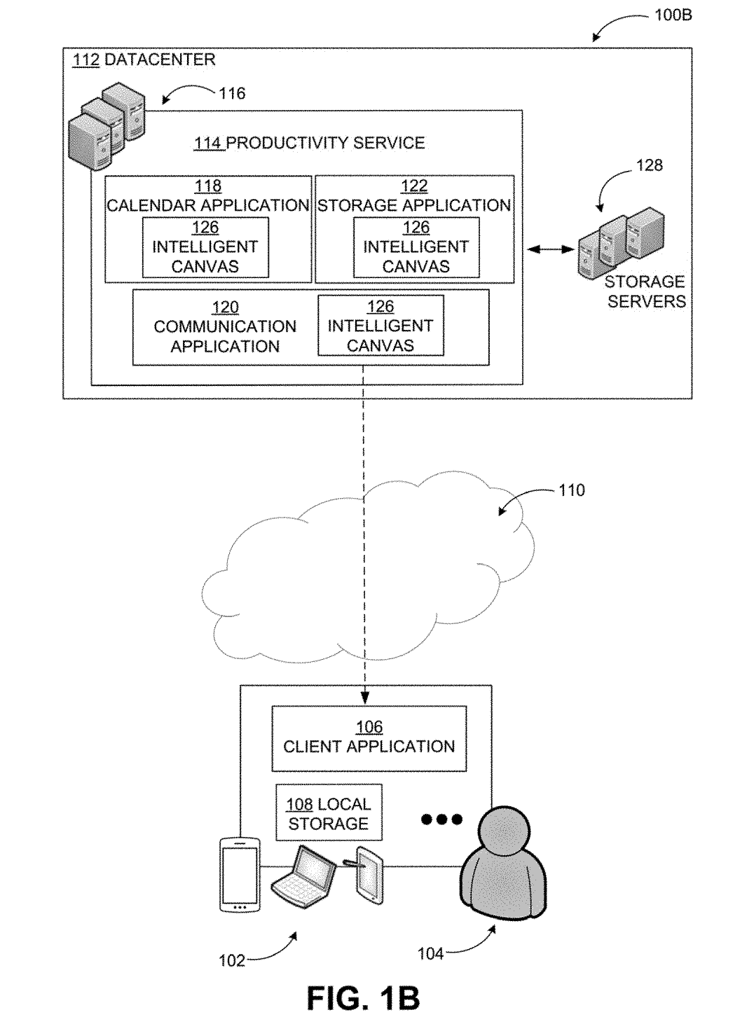

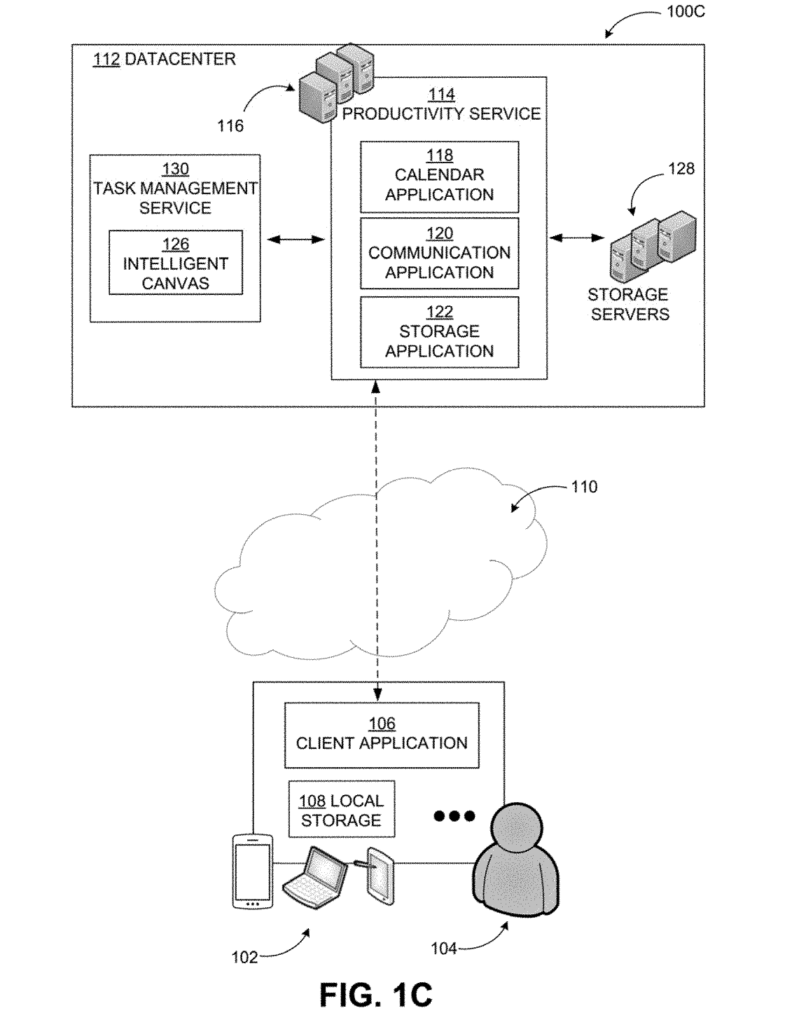

FIGS. 1A through 1C include display diagrams illustrating an example network environment where a system to implement an intelligent canvas to provide suggestions for task completion may be implemented.

As illustrated in diagrams 100A through 100C, an example system may include a datacenter 112 executing a productivity service 114 on at least one processing server 116. The productivity service 114 may provide users various services and/or applications, including a calendar application 118, a communication application 120, a storage application 122, and a task management application 124, among other similar applications (e.g., word-processing, presentation, spreadsheet, and notebook applications), that enable users create, edit, manage, store, and share information. The productivity service 114 may be configured to interoperate with a client application 106 through one or more client devices 102 over one or more networks, such as network 110. For example, the productivity service 114 may allow users to access its services and/or applications through the client application 106 executed on the client devices 102. The client devices 102 may include a desktop computer, a laptop computer, a tablet computer, a vehicle-mount computer, a smart phone, or a wearable computing device, among other similar devices. In other examples, the productivity service 114 may be provided to a tenant (e.g., a business, an organization, or similar entities), which may configure and manage the services for their users. The information that is created, edited, stored, and/or shared using the various services and/or applications of the productivity service 114 may be stored locally in local storage 108 of the client devices 102 and/or remotely in storage servers 128 of the datacenter 112.

In one embodiment, as illustrated in diagram 100A of FIG. 1A, the processing server 116 may be operable to execute an intelligent canvas 126 to provide suggestions for task completion, where the intelligent canvas 126 may be integrated with the task management application 124 of the productivity service 114. In another embodiment, as illustrated in diagram 100B of FIG. 1B, the intelligent canvas 126 may be integrated with each of the services and/or applications provided by the productivity service, including the calendar application 118, the communication application 120, and the storage application 122, for example. In a further embodiment, as illustrated in diagram 100C of FIG. 1C, the intelligent canvas 126 may be an integrated module of a separate task management service 130 configured to serve the productivity service 114 and/or multiple applications associated with the productivity service 114, such as the client application 106. As described herein, the productivity service 114, the various applications provided by the productivity service 114, the task management service 130, and the intelligent canvas 126 may be implemented as software, hardware, or combinations thereof.

In an example embodiment, the intelligent canvas 126 may be configured to receive content input from a user 104. The content input may be received through one or more input devices communicatively coupled with a device on which the intelligent canvas is being executed, such as one of the client devices 102. The input devices may enable a keyboard input, a mouse input, a pen input, a touch input, an optical capture, a voice input, a gyroscopic input, and/or an eye-tracking input, for example. To provide an example, the user 104 may speak a task he or she needs to complete into a microphone of the device, such as “Deposit check at bank,” and the intelligent canvas 126 may employ natural language processing techniques, such as speech recognition, to convert the speech into text.

The intelligent canvas 126 may be configured to determine a context for the content input based on information associated with the user 104, a time, a location, and/or one or more active applications. User information may be retrieved from a directory service associated with the user 104, such as a a directory service associated with the productivity service 114 that may be personal to the user 104 or may be for a company that the user 104 is an employee of, for example. The user information may include presence information and contacts associated with the user 104. For example, the user information may indicate if the user 104 is busy or free to perform a task, such as depositing the cheek at the bank. Location information may be retrieved from location based services, which use information on geographical positions of devices to drive real insight from data tied to specific locations where activities take place. In one example, location based services may be used to identify a location of a person or object, such as the nearest bank. They may also provide information associated with that person or object, such as contact information and operating hours of the nearest bank. The active applications may include the applications provided by the productivity service 114, such as the calendar application 118, the communication application 120, and the storage application 122. Information retrieved from the active applications may include content from calendar items, communication items, and stored documents, among other similar items. For example, content from an email received by the user 104 through the communication application 120 may be used to determine context for the content input (e.g., a bank name and a branch which the user 104 is associated with may be determined based on bank statements provided via email).

The intelligent canvas 126 may be configured to perform an inference for a suggestion to complete a task associated with the content input based on the determined context and the content input. Continuing with the example provided above, the suggestion may indicate a distance from the user 104, based on a location of the client devices 102, to the nearest bank with which the user 104 is affiliated, and an option to get directions to that bank. The suggestion may also provide what time the bank closes so that the user 104 doesn't waste his or her time traveling to the bank when it's closed. The suggestion may then be implemented to complete the task. In one embodiment, the intelligent canvas 126 may be integrated with a rich application that is capable of executing the suggestion to complete the task. In other embodiments, the intelligent canvas 126 may be configured to interact with one or more other applications associated with the productivity service 114 to complete the tasks. For example, the intelligent canvas 126 may send instructions based on the suggestion to the other applications for execution in order to complete the task.

A person's day may be full of both personal and work related tasks that need to be completed. While the person may plan the tasks that should be completed by creating some sort of structure, such as a to-do list or a task list, the person must then actually take the time to complete them. Embodiments are directed to an intelligent canvas that may provide suggestions for how to complete tasks within a person's task list, for example, and then implement those suggestions in order to complete the tasks. The implementation of the intelligent canvas may increase user efficiency as the suggestions and subsequent implementation of the suggestions may prompt the user to quickly and more efficiently complete the tasks. For example, one task may be to print out a concert ticket. Traditionally, the user may have to figure out a location at which the ticket is stored or may be retrieved from (for example, within a cloud storage application or within a communication application), access that location to retrieve the ticket, and then select to print the ticket. However, implementing the intelligent canvas, in response to the receiving the task as content input, the intelligent canvas may be configured to provide a suggestion to the user that indicates the location of the ticket and an option to print the ticket through a single user action.

Embodiments, as described herein, address a need that arises from a very large scale of operations created by software-based services that cannot be managed by humans. The actions/operations described herein are not a mere use of a computer, but address results of a system that is a direct consequence of software used as a service offered in conjunction with a large number of users consuming productivity services to schedule, manage, and perform tasks for many different facets of their life.

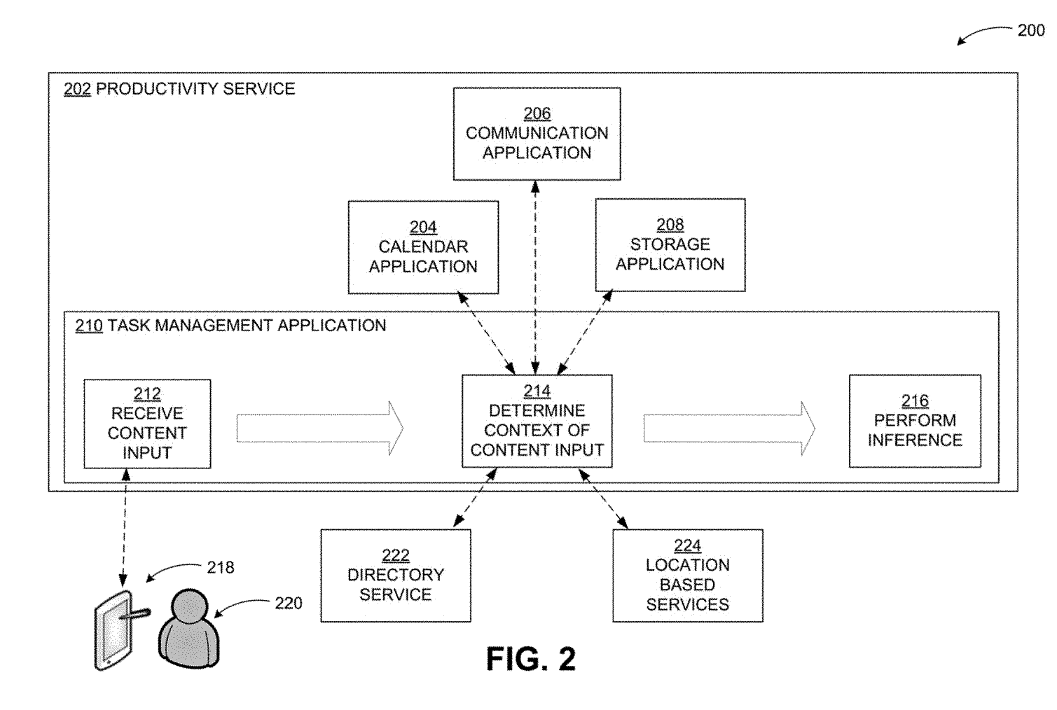

FIG. 2 includes a display diagram illustrating conceptually an example set of actions and components for determining a context of received content input in order to perform an inference based on the determined context and the content input.

As shown in a diagram 200, a productivity service 202 may provide a user 220 various services and/or applications, including a calendar application 204, a communication application 206, a storage application 208, and a task management application 210, among other similar applications (e.g., word-processing, presentation, spreadsheet, and notebook applications), that enable users create, edit, manage, store, and share information. The user 220 may access the services and/or applications of the productivity service 202 by executing a thin (e.g., a web browser) or a thick (e.g., a locally installed client application) version of a respective application associated with the productivity service 202 through a client device, such as a tablet 218 of the user 220.

In an example embodiment, the user 220 may execute a thin version of the task management application 210 through the tablet 218 in order to create and manage a task list, for example. The task management application 210 may be configured to implement an intelligent canvas to provide suggestions for completion of the tasks input into the task list by the user 220. For example, the user 220 may have a handwritten to-do list and thus, may use a camera of the tablet 218 to capture an image of the handwritten to-do list to import into the task management application 210. The task management application 210 may be configured to employ natural language processing techniques, such as optical character recognition, to convert the handwriting into text. The text may be received by the intelligent canvas as the content input 212. To provide an example scenario, the user's 220 handwritten to-do list, may read “Email John Annual Budget Report,” and “Drop off package.”

A context for the content input may be determined 214 based on information associated with the user 220, a time, a location, and/or one or more active applications. User information may be retrieved from a directory service 222 associated with the productivity service 202. For example, the directory service 222 may be a directory service of a corporation who is a tenant of the productivity service 202, where the user 220 may be an employee of that corporation, for example. The user information may include presence information and contacts associated with the user 220. For example, the user information may determine when the user 220 is available to perform a task, such as if the user 220 is online and thus capable of sending the email. Additionally, an email address and other information for “John,” such as a telephone number, a photograph, presence information, and a job title may be obtained from the user's 220 contacts within the directory service 222. Location information may be retrieved from location based services 224, which may identify a location of a person or object, such as the nearest post office or other similar postal services that mail or ship packages. The location based services 224 may also provide information associated with that person or object, such as contact information and operating hours of the post office or other postal services. The active applications may include the applications provided by the productivity service 202, such as the calendar application 204, the communication application 206, and the storage application 208. Information retrieved from the active applications may include content from calendar items, communication items, and stored documents, among other similar items. For example, a document tided “Annual Budget Report” stored within the storage application 208 and a number of emails with work-related content previously transmitted and/or received by the user 220 to and/or from an alias “John” may be used to determine context for the content input of “Email John Annual Budget Report.” For a further example, content from an email received by the user 220 through the communication application 206 for a shipping or package label may be used to determine context for the content input of “Drop off package” (e.g., which of the postal services the user 220 is shipping the package through).

An inference may be performed 216 for a suggestion to complete a task associated with the content input based on the determined context and the content input. For example, the suggestions for the task associated with the content input “Email John Annual Budget Report,” may indicate that the document “Annual Budget Report” was found in the storage application 208, and provide an option to create a new email with the document as an attachment. To implement the suggestion, the task management application 210 may be configured to interact with the communication application 206 and the storage application 208 to create a new email to “John” and retrieve and attach the document to the new email, respectively. In some examples, a subject line and message within the body of the email may also be inserted into the email based on the determined context, and the email may be automatically sent without any additional input by the user 220. For example, the subject line may read “Annual Budget Report” and the message may be a default message, such as “See document attached.”

To provide a further example, the suggestion for the task associated with the content input “Drop off package” may indicate a distance from the user 220, based on a location of the tablet 218, to the nearest store associated with the particular postal service that the user 220 is shipping the package through, and provide an option to get directions to that particular store. To implement the suggestion, the task management application 210 may interact with the location based services 224 to provide the user 220 with one or more of a map and directions, where the task management application 210 may automatically enter the store as input into the location based services 224.

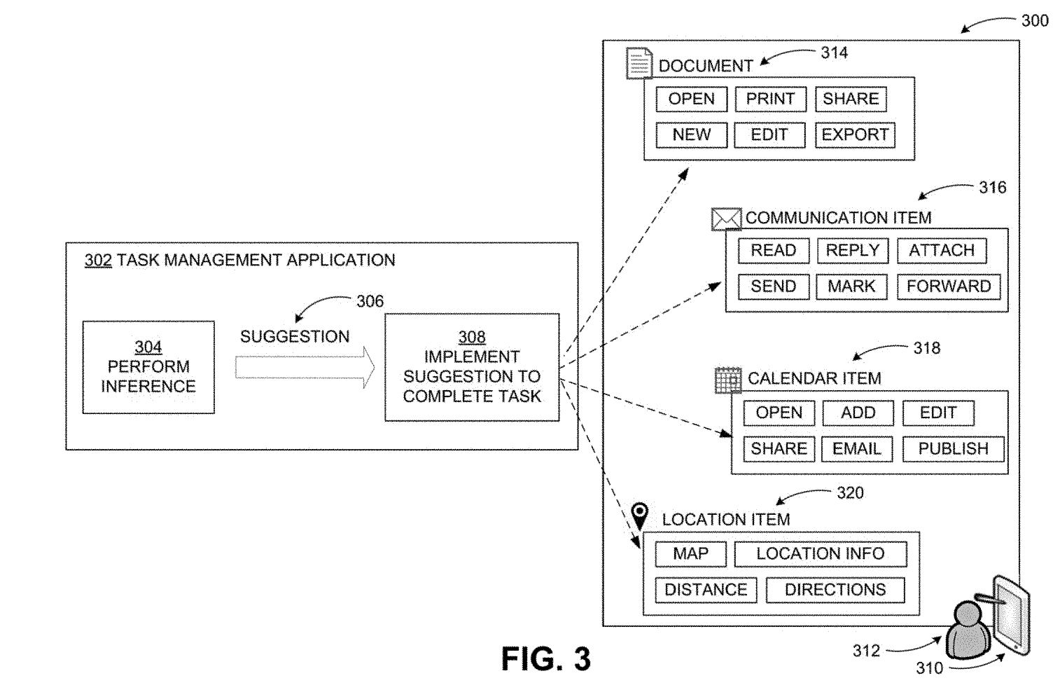

FIG. 3 includes a display diagram illustrating conceptually an example set of actions and components for implementing a suggestion to complete a task associated with content input yielded from an inference performed based on the content input and a context determined for the content input.

As shown in a diagram 300, a task management application 302 associated with a productivity service that enables a user 312 to create and manage task lists, for example, may be configured to implement an intelligent canvas to provide suggestions to the user 312 for task completion. The user 312 may access the task management application 302 by executing a thin (e.g., a web browser) or a thick (e.g., a locally installed client application) version of the task management application 302 through a client device, such as a tablet 310 of the user 312.

As described in detail in FIG. 2 above, in response to receiving content input on the intelligent canvas, a context of the content input may be determined, and an inference may be performed 304 for a suggestion 306 to complete a task associated with the content input based on the determined context and the content input. The suggestion 306 may then be implemented to complete the task 308. In some embodiments, the task management application 302 may be a rich application configured to implement the suggestion itself. In other embodiments, the task management application 302 may act in conjunction with one or more applications of the productivity service, such as a communication application, a calendar application, a storage application, a word-processing application, a presentation application, a notebook application, and/or a spreadsheet application, to implement the suggestion 306 to complete the task. How the suggestion 306 is implemented may be dependent on a type of the task associated with the content input. For example, the task may be associated with one or more of a document 314, a communication item 316, a calendar item 318, and a location item 320.

If the task is associated with a document 314, the suggestion 306 may be implemented by opening an existing document, creating a new document, editing a document, sharing a document, exporting a document, and/or printing a document, among other similar actions. For example, if the content input received on, the intelligent canvas is “Slideshow for carbon cycle lesson,” and the determined context reveals that no document stored in a storage application, presentation application, or other similar application has content related to the carbon cycle, the suggestion may be to create a new slideshow. The task management application 302 may implement the suggestion by interacting with a presentation application to create a new slideshow. In some embodiments, the new slideshow may be automatically titled “Carbon Cycle Lesson” based on the content input and, if the determined context reveals that other slideshows associated with the presentation application having “lesson” in the title have a similar format and/or background, the new slideshow may be automatically created with the same format and/or background. In another example, if the determined content had revealed that a slideshow document stored in the storage application included content related to the carbon cycle, the task management application 302 may implement the suggestion by interacting with the storage application to retrieve the slideshow document and the presentation application to allow the retrieved slideshow document to be edited.

If the task is associated with a communication item 316, the suggestion 306 may be implemented by opening a communication item for the user to read or view, creating a new communication item, sending a communication item, replying to a communication item, forwarding a communication item, attaching a document to the communication item, and/or marking a communication item (e.g., marking a communication item as read/unread, marking to categorize a communication item, or marking to flag a communication item for follow up or importance), among other actions. For example, the content input received may be “Email Jane business trip receipts.” The determined context for the content input may reveal a file labeled “business trip receipts” stored within a storage application, and previous emails comprising business receipts as attachments that had been sent from the user 312 to an alias “Jane” within a communication application. Based on the content input and determined context, the suggestion may indicate that the business receipts were found in the storage application, and may provide an option to send an email to Jane with the business trip receipts attached. The task management application 302 may implement the suggestion by interacting with the storage application to retrieve the file and the communication application to create a new email to Jane with the retrieved file as an attachment of the email. In some examples, a subject line and message within the body of the email may be automatically inserted into the email based on the determined context, and the email may be sent without any action needed from the user 312. For example, the subject line may read “Business Trip Receipts” and the message be copied from the previous emails from the user to “Jane”.

If the task is associated with a calendar item 318, the suggestion 306 may be implemented by opening a calendar item, adding a calendar item to a calendar, editing a calendar item, sharing a calendar item or a calendar, and/or publishing a calendar item or a calendar. For example, content input is “Hair appointment Wednesday at 2 pm,” and the determined context reveals that the user 312 has no other conflicts at that date and time based on the user's calendar within a calendar communication, the suggestion may be to add the hair appointment to the user's calendar. The task management application 302 may implement the suggestion by interacting with the calendar application to add a new calendar item to the calendar for the particular date and time of the hair appointment. In another example, if the determined context revealed that content of an existing calendar item was associated with a hair appointment for another date or time, the suggestion may indicate that another similar appointment exists, and provide an option to view the previously scheduled appointment. The task management application 302 may implement the suggestion by interacting with the calendar application to open the potentially conflicting calendar item and suggest the user 312 edit the calendar item to reflect the new date and time of Wednesday at 2 pm.

If the task is associated with a location item 320, the suggestion 306 may be implemented by providing a map associated with the location item, location information associated with the location item, directions associated with the location item, and/or a distance associated with the location item. For example, the content input may be “Buy Flowers,” and the determined context, based on location information, may reveal a nearby floral shop that has extended business hours to fit the availability of the user 312 determined based on the user's calendar and/or presence information. The suggestion may provide a distance of the floral shop from the user 312 based on a location of the user's device (e.g., the tablet 310), an option to get directions, and/or an option to contact the floral shop so the user may order the flowers ahead of time for pick up, for example. The task management application 302 may implement the suggestion by interacting with location based services to provide the directions to the floral shop and provide contact information, such as a telephone number, email address and/or website of the floral shop.

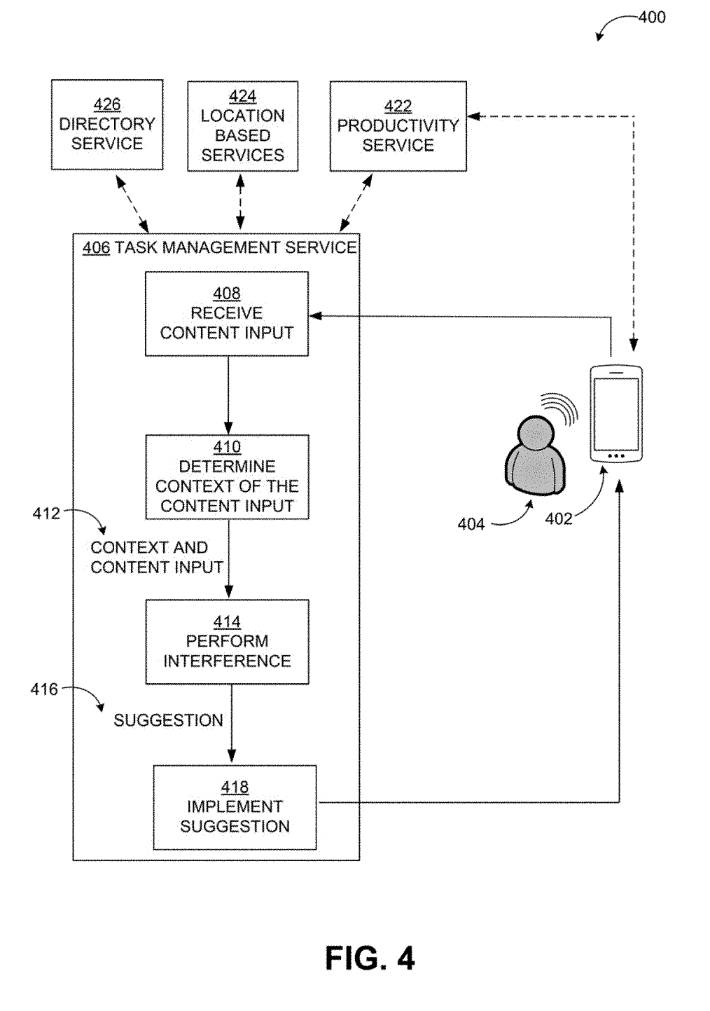

FIG. 4 includes a display diagram illustrating conceptually an example set of actions and components for providing suggestions for task completion.

As shown in a diagram 400, a task management service 406 may be configured to allow a user 404 to create and manage tasks, where an intelligent canvas may be implemented to provide suggestions for completion of the tasks. The task management service 406 may be associated with a productivity service 422 that may provide a user 404 various services and/or applications, including a calendar application, a communication application, and a storage application, among other similar applications (e.g., word-processing, presentation, spreadsheet, and notebook applications), that enable users create, edit, manage, store, and share information. The user 404 may access the task management service 406 and/or the productivity service 422 by executing a thin (e.g., a web browser) or a thick (e.g., a locally installed client application) version of a respective application associated with the task management service 406 and/or the productivity service 422 through a client device, such as a smart phone 402 of the user 404.

In an example embodiment, the user 404 may execute a thick version of the application associated with the task management service 406 through the smart phone 402 in order to create and manage a task list, for example. To provide an example scenario, the user 404 may speak a task he or she needs to complete into a microphone of the smart phone 402, such as “Pick up Bob's dry-cleaning,” and the task management service 406 may use natural language processing techniques, such as speech recognition, to convert the speech into text. The text may be received by the intelligent canvas as the content input 408.

A context for the content input may be determined 410 based on information associated with the user 404, a time, a location, and/or one or more active applications. User information may be retrieved from a directory service 426 associated with the user 404. The user information may include presence information and contacts associated with the user 404. For example, information for Bob, such as an email, a telephone number, a photograph, and presence information, may be obtained from the user's 404 contacts within the directory service 426. Location information may be retrieved from location based services 424, which may identify a location of a person or object, such as a location of dry-cleaning services within the area. The location based services 424 may also provide information associated with that person or object, such as contact information and operating hours of the dry-cleaning services. The active applications may include the applications provided by the productivity service 422, such as the calendar application, the communication application, and the storage application. Information retrieved from the active applications may include content from calendar items, communication items, and stored documents, among other similar items. For example, content of an email from Bob within the communication application may include instructions for picking up his dry-cleaning, where the instructions may include a particular dry-cleaning service, a certain day the dry-cleaning is to be picked up, and his claim ticket and receipt.

An inference may be performed 414 for a suggestion 416 to complete a task associated with the content input based on the determined context and the content input 412. For example, based on the information from the location based services 424 and content from the email, the suggestion 416 may indicate that the location of the particular dry-cleaning service is 2.1 miles away from the user 404, the operating hours of the dry-cleaning service are from 7 am-5 pm on the certain day that Bob's dry-cleaning is to be picked up, and provide an option to get directions to the particular dry-cleaning service. Based on the operating hours and the user's availability on that certain day (e.g., additional context determined from presence information and/or a user's calendar within a calendar application, for example), a suggested time period in which to pick up the dry-cleaning may also be included. The suggestion 416 may further indicate that the dry-cleaning claim ticket and receipt was found in the user's email from Bob, and provide an option for the user 404 to open and/or print the claim ticket and receipt.

The suggestion 416 may be implemented 418 to complete the task. How the suggestion 416 is implemented may be dependent on a type of the task, as described in detail in conjunction with FIG. 3. For example, the task may be associated with one or more of a document, a communication item, a calendar item, and a location item. In some embodiments, the task management service 406 may be configured to implement 418 the suggestion 416 in conjunction with one or more applications associated with the productivity service 422. Continuing with the example provided above, the task associated with the content input (e.g., to pick up Bob's dry-cleaning) may be associated with a location item, the dry-cleaning service. Therefore, as described above, the suggestion 416 may be implemented 418 by providing a distance to the location of the dry-cleaning service, location information associated with the dry-cleaning service (e.g., the operating hours), and directions to the dry-cleaning service. In some examples, the task management service 406 may be configured to interact with the location based services 426 to implement the suggestion 416. Additionally, the task may be associated with a document, the claim ticket and receipt for Bob's dry-cleaning. Therefore, the task may further be implemented by opening and/or printing the claim ticket and receipt. In some examples, the task management service 406 may be configured to interact with one or more applications of the productivity service 422 to implement the suggestion 416, such as the communication application to retrieve the claim ticket and receipt from Bob's email and a word-processing or portable document format (pdf) reader application to open and print the claim ticket and receipt.

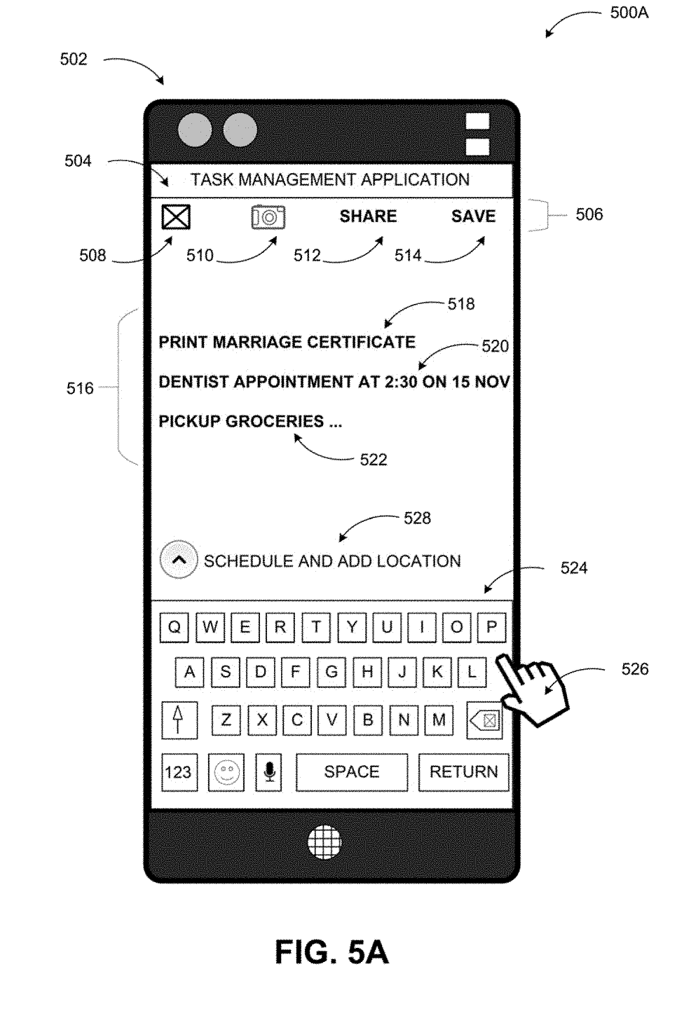

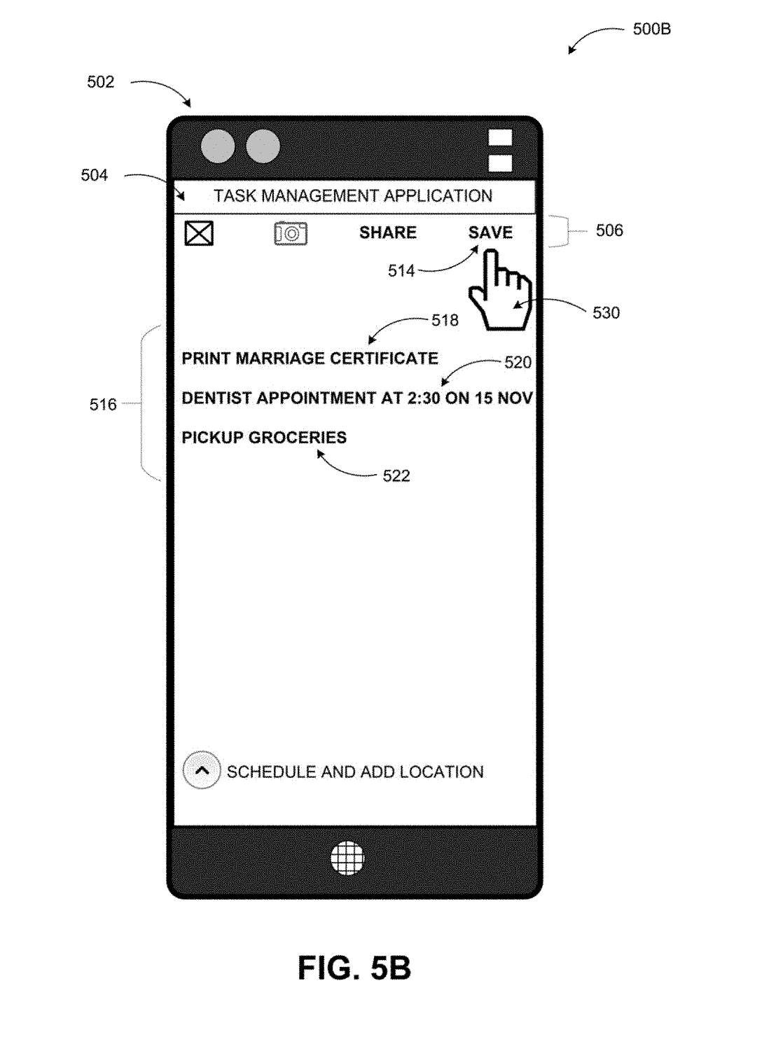

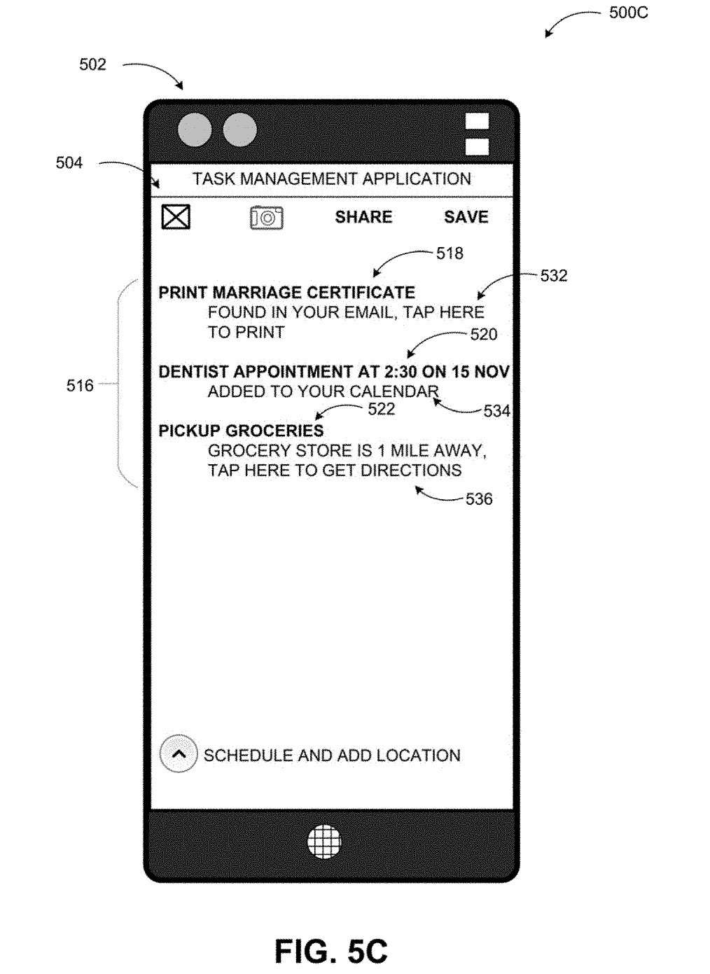

FIGS. 5A through 5C include display diagrams illustrating an example user interface of a task management application configured to implement an intelligent canvas to provide suggestions for task completion. A task management application associated with a productivity service may enable a user to create to-do lists or task lists, for example, to help the user manage their everyday tasks. An intelligent canvas configured to provide suggestions for task completion may be an integral module within the task management application, where the task management application may be executed on a mobile device 502, as shown in a diagrams 500A through 500C.

As shown in a diagram 500A of FIG. 5A, a user interface 504 of the task management application presented through a display screen of the mobile device 502 may include a tool bar 506 with one or more control elements to allow the user to interact with the task management application. The control elements may include an exit control 508, a camera control 510, a share control 512, and a save control 514. The exit control 508 may allow the user to exit out of the task management application. The camera control 510 may allow the user to take a picture of a handwritten to do-list, for example, through a camera of the mobile device 502 for import into the task management application. Natural language processing techniques, such as optical character recognition, may be employed to convert the handwriting into text. The share control element 512 may enable the user to share the to-do list or task list with other people and/or other devices or applications associated with the user. The save control element 514 may enable the user to save the to-do list or task list once the user has finished inputting items into the list.

In an example scenario, the user may input items 518, 520, and 522 into a task list 516. A first item 518 may be to print a marriage certificate, a second item 520 may be a dentist appointment at a particular date and time, and a third item 522 may be to pick up groceries. The user may input the items using touch input 526 through a keyboard 524 presented on a display screen of the mobile device 502. For example, in response to the user touching any portion of the user interface 504, the keyboard 524 may be invoked such that the user may input the items into the task list 516. The user may also have an option 528 to schedule and add location to the task list 516. Once the user has finished inputting items into the task list 516, the keyboard 524 may be dismissed and the user may select 530 the save control element 514 from the tool bar 506, as illustrated in a diagram 500B of FIG. 5B.

Upon selection 530 of the save control element 514, the intelligent canvas integrated with the task management application, may be configured to provide suggestions 532, 534, 536 for completion of respective items 518, 520, 522 within the task list 516, as shown in diagram 500C of FIG. 5C. As previously discussed, the intelligent canvas may be configured to receive content input and determine a context for the content input based on information associated with the user, a time, a location, and/or one or more active applications, including other applications provided by the productivity service such as a calendar application, a communication application, and a storage application, among others. The intelligent canvas may then be configured to perform an inference for a suggestion to complete a task associated with the content input based on the determined context and the content input, and implement the suggestion to complete the task.

For example, the intelligent canvas may be configured to receive each of the items 518, 520, 522 as content input. For the first item 518, information associated with the communication application may reveal an email with an attachment titled “Marriage Certificate” in the user's inbox. Therefore, in a first suggestion 532, the intelligent canvas may indicate that the marriage certificate was found in the user's email, and allow the user to print the marriage certificate through the task management application by performing a tap action or other similar action on the user interface 504. For example, the task management application may launch the communication application in response the user action, and the attachment within the email will be automatically opened and printed through the communication application.

For the second item 520, the intelligent canvas may interact with the calendar application or other similar scheduling service or application to determine whether or not the user is available at the'particular time and date for which the dentist appointment is scheduled based on a calendar of the user. If no conflicts are determined, the dentist appointment may be automatically added to the user's calendar. Therefore, in a second suggestion 534, the intelligent canvas may indicate that the appointment has been added to the user's calendar. However, if a conflict had been determined, the dentist appointment may not be automatically added to the user's calendar. Instead, the suggestion may alert the user to the conflict, indicate what the conflicting appointment is, and provide an option to reschedule one or the other. For example, the suggestion may include contact information for the dentist office and for the person or entity associated with other appointment so that the user may be able to quickly get ahold of one or the other to reschedule.

For the third item 522, the intelligent canvas may interact with location based services to identify a location of the nearest grocery store. Therefore, in a third suggestion 536, the intelligent canvas may indicate that there is a grocery store within a certain distance, and allow the user to get directions to that store by performing a tap action or other similar action on the user interface 504. For example, the task management application may launch the location based service in response the user action, and the location of the grocery store may be automatically entered as the input.

The examples provided in FIGS. 1A through 5C are illustrated with specific systems, services, applications, and user interface displays. Embodiments are not limited to environments according to these examples. Proving suggestions for task completion through an intelligent canvas may be implemented in environments employing fewer or additional systems, services, applications, and user interface displays. Furthermore, the example systems, services, applications, and user interface displays shown in FIGS. 1A through 5C may be implemented in a similar manner with other user interface or action flow sequences using the principles described herein.

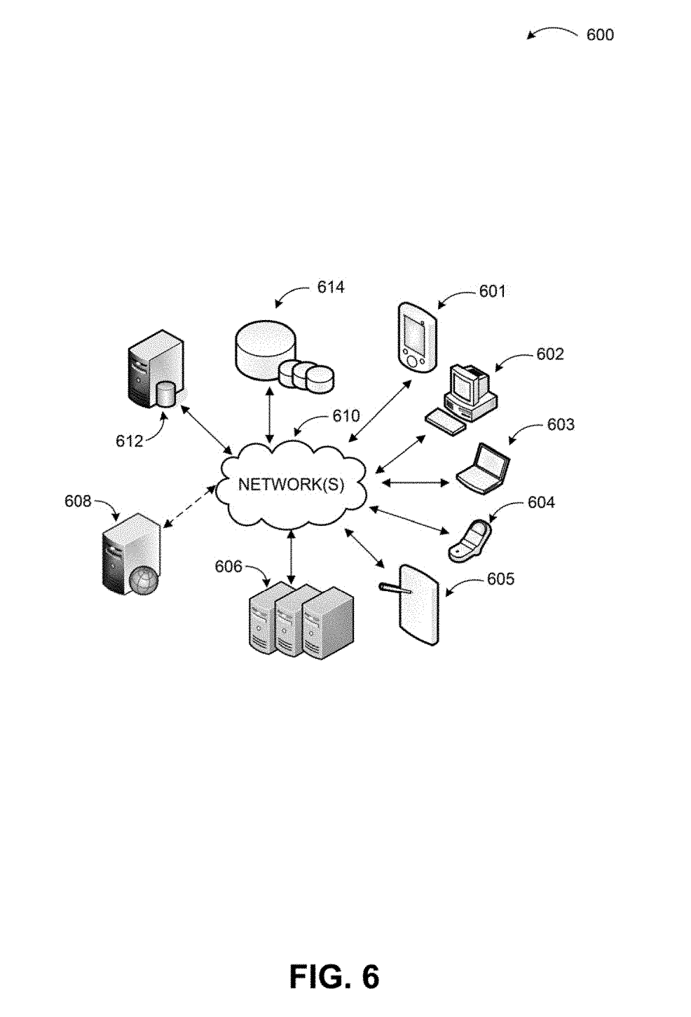

FIG. 6 is a networked environment, where a system according to embodiments may be implemented. An intelligent canvas as described herein may be employed in conjunction with hosted applications and services (for example, the task management application 124 associated with the productivity service 114, the client application 106 associated with the productivity service 114, various other applications associated with the productivity service 114, the productivity service 114, or the task management service 130) that may be implemented via software executed over one or more servers 606 or individual server 608, as illustrated in diagram 600. A hosted service or application may communicate with client applications on individual computing devices such as a handheld computer 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or client application. One or more of the servers 606 or server 608 may be used to provide a variety of services as discussed above. Relevant data may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed to implement an intelligent canvas to provide suggestions for task completion. Furthermore, the networked environments discussed in FIG. 6 are for illustration purposes only. Embodiments are not limited to the example applications, engines, or processes.

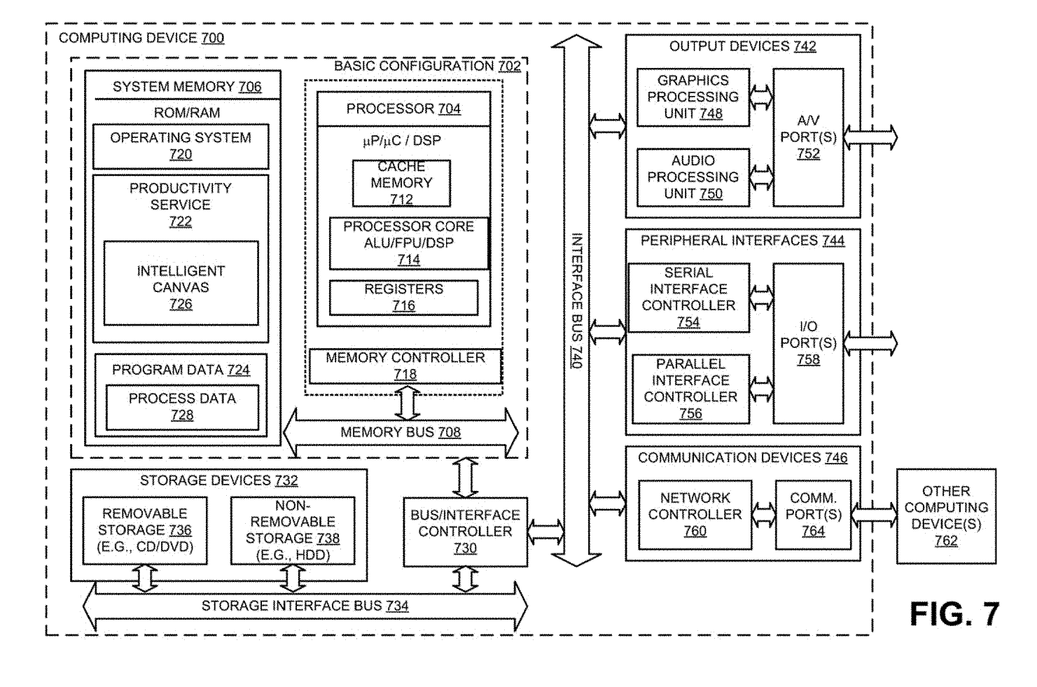

FIG. 7 is a block diagram of an example computing device, which may be used to implement an intelligent canvas to provide suggestions for task completion.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a productivity service 722, and program data 724. The productivity service 722 may include an intelligent canvas 726, which may be an integrated modulo of one or more applications of the productivity service 722. The intelligent canvas 726 may be configured to receive content input on the intelligent canvas, determine a context for the input based on information associated with a user, a time, a location, and/or one or more active applications, perform an inference for a suggestion to complete a task associated with the content input based on the determined context and the content input, and implement the suggestion to complete the task. The program data 724 may include, among other data, process data 728, such as the information obtained to determine the context for the content input and perform the inference for the suggestion, the suggestion, and instructions to implement the suggestion, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more 110 ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to implement an intelligent canvas to provide suggestions for task completion. These methods can be implemented in any number of ways, including the structures described herein. One such way may be by machine operations, of devices of the type described in the present disclosure. Another optional way may be for one or more of the individual operations of the method to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

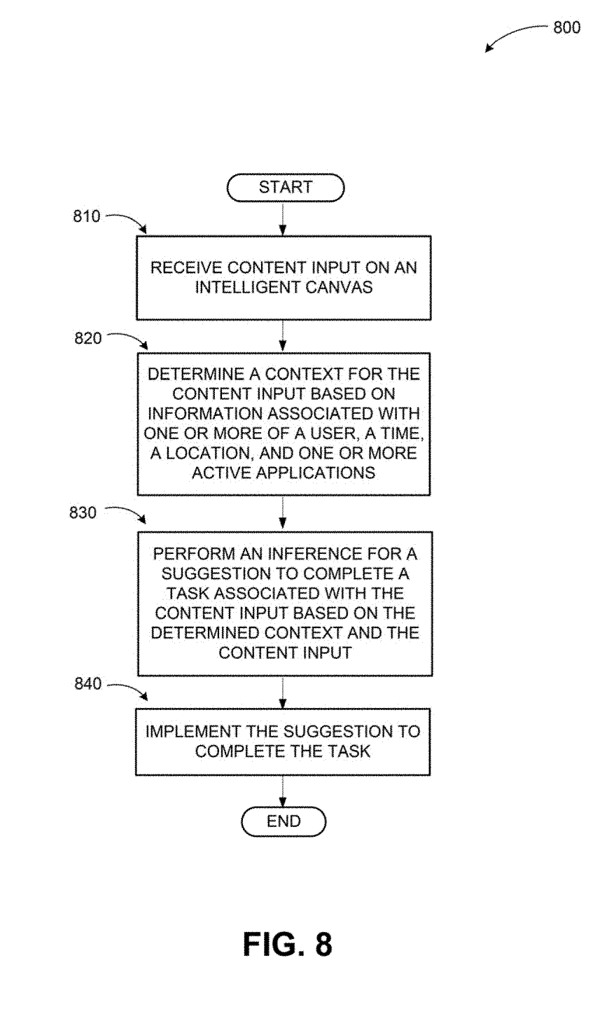

FIG. 8 illustrates a logic flow diagram of a method to implement an intelligent canvas to provide suggestions for task completion. Process 800 may be implemented on a computing device, server, or other system. An example server configured to execute an intelligent canvas associated with a productivity service comprises a communication interlace to facilitate communication between the server and one or more client devices. The example serve may also comprise a memory to store instructions, and one or more processors coupled to the memory. The processors, in conjunction with the instructions stored on the memory, may be configured to provide suggestions for task completion.

Process 800 begins with operation 810, where the processors may be configured to receive content input on the intelligent canvas. The content input may be received through one or more input devices communicatively coupled to a device on which the productivity service is being executed. The input devices may enable a keyboard input, a mouse input, a pen input, a touch input, an optical capture, a voice input, a gyroscopic input, and/or an eye-tracking input, for example. In some embodiments, natural language processing techniques may be employed upon receipt of the content input based on a format of the content input.

At operation 820, the processors may be configured to determine a context for the input based on information associated with a user, a time, a location, and/or one or more active applications. At operation 830, the processors may be configured to perform an inference for a suggestion to complete a task associated with the content based on the determined context and the content input.

At operation 840, the processors may be configured to implement the suggestion to complete the task. How the suggestion is implemented may be dependent on a type of the task. For example, the task may be associated with one or more of a document, a communication item, a calendar item, and a location item. In some embodiments, the processors may be configured to implement the suggestion to complete the task in conjunction with one or more applications associated with the productivity service.

The operations included in process 800 are for illustration purposes. Providing suggestions for task completion through an intelligent canvas may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, means to implement an intelligent canvas associated with a productivity service to provide suggestions for task completion may be provided. Example means may include receiving content input on the intelligent canvas, determining a context for the content input based on information associated with a user, a time, a location, and/or one or more active applications, performing an inference for a suggestion to complete a task associated with the content input based on the determined context and the content input, and implementing the suggestion to complete the task.

According to some examples, methods to implement an intelligent canvas associated with a productivity service to provide suggestions for task completion may be provided. An example method may include receiving content input on the intelligent canvas, determining a context for the content input based on information associated with a user, a time, a location, and/or one or more active applications, performing an inference for a suggestion to complete a task associated with the content input based on the determined context and the content input, and implementing the suggestion to complete the task.

In other examples, in response to a determination that the task is associated with a document based on the determined context and the content input, opening the document, creating the document, editing the document, sharing the document, exporting the document, and/or printing the document to implement the suggestion to complete the task. In response to a determination that the task is associated with a calendar item based on the determined context and the content input, opening the calendar item, adding the calendar item to a calendar, editing the calendar item, sharing the calendar item or the calendar, and/or publishing the calendar item or the calendar to implement the suggestion to complete the task. In response to a determination that the task is associated with a communication item based on the determined context and the content input, opening the communication item, sending the communication item, replying to the communication item, forwarding the communication item, attaching a document to the communication item, and/or marking the communication item to implement the suggestion to complete the task. In response to a determination that the task is associated with a location item based on the determined context and the content input, providing a map associated with the location item, location information associated with the location item, directions associated with the location item, and/or a distance associated with the location item to implement the suggestion to complete the task.

In further examples, the information associated with the user may be retrieved from a directory service. The information associated with the user may include presence information and/or contacts of the user. The information associated with the location may be retrieved from one or more location based services. The information associated with the location may include a geographical location of a person, a place, or an object and/or information associated with the person, the place, or the object. The information associated with the active applications may be retrieved from a calendar application, a communication application, and/or a storage application associated with the productivity service. The information associated with the active applications may include content of calendar items within the calendar application, content of communication items within the communication application, and for content of documents within the storage application.

According to some embodiments, servers configured to implement an intelligent canvas associated with a productivity service to provide suggestions for task completion may be described. An example server may include a communication interlace configured to facilitate communication between the server and one or more client devices, a memory configured to store instructions, and one or more processors coupled to the communication interlace and the memory. The processors may be configured to receive content input on the intelligent canvas through the communication interface, determine a context for the content input based on information associated with a user, a time, a location, and/or one or more active applications, perform an inference for a suggestion to complete a task associated with the content input based on the determined context and the content input, and implement the suggestion to complete the task.

In other embodiments, the processors may be further configured to receive the content input through one or more input devices communicatively coupled to the client devices. The input devices may allow a keyboard input, a mouse input, a pen input, a touch input, an optical capture, a voice input, a gyroscopic input, and/or an eye-tracking input. The processors may be further configured to employ one or more natural language processing techniques based on a type of the input received. The intelligent canvas is an integral module of a task management application associated with the productivity service, an integral module of one or more of a calendar application, a communication application, and a storage application associated with the productivity service, or an integral module of a separate task management service configured to serve the productivity service.

According to some examples, systems configured to implement an intelligent canvas associated with a productivity service to provide suggestions for task completion may be described. An example system may include a a first server configured to host the productivity service, and a second server configured to host a task management service configured to serve the productivity service, where the intelligent canvas may be an integral module of the task management service. The second server may include a communication interface configured to facilitate communication between the first server and the second server, a memory configured to store instructions, and one or more processors coupled to the communication interface and the memory. The processors may be configured to receive content input on the intelligent canvas, determine a context for the content input based on information associated with a user, a time, a location, and/or one or more active applications, perform an inference for a suggestion to complete a task associated with the content input based on the determined context and the content input, and implement the suggestion to complete the task in conjunction with one or more applications associated with the productivity service.

In other examples, the suggestion to complete the task may be implemented based on a type of item the task is associated with. The task may be associated with a calendar item, a communication item, a document, and/or a location item. The applications associated with the productivity service may include a calendar application, a communication application, a storage application, a word-processing application, a presentation application, a notebook application, and/or a spreadsheet application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to implement an intelligent canvas associated with a productivity service to provide suggestions for task completion, the method comprising:
receiving content input on the intelligent canvas;
determining a context for the content input based on information associated with one or more of a user, a time, a location, and one or more active applications;
performing an inference for a suggestion to complete a task associated with the content input based on the determined context and the content input; and
implementing the suggestion to complete the task.

2. The method of claim 1, wherein implementing the suggestion to complete the task comprises:
in response to a determination that the task is associated with a document based on the determined context and the content input, one or more of: opening the document, creating the document, editing the document, sharing the document, exporting the document, and printing the document.

3. The method of claim 1, wherein implementing the suggestion to complete the task comprises:
in response to a determination that the task is associated with a calendar item based on the determined context and the content input, one or more of: opening the calendar item, adding the calendar item to a calendar, editing the calendar item, sharing the calendar item or the calendar, and publishing the calendar item or the calendar.

4. The method of claim 1, wherein implementing the suggestion to complete the task comprises:
in response to a determination that the task is associated with a communication item based on the determined context and the content input, one or more of: opening the communication item, sending the communication item, replying to the communication item, forwarding the communication item, attaching a document to the communication item, and marking the communication item.

5. The method of claim 1, wherein implementing the suggestion to complete the task comprises:
in response to a determination that the task is associated with a location item based on the determined context and the content input, providing one or more of: a map associated with the location item, location information associated with the location item, directions associated with the location item, and a distance associated with the location item.

6. The method of claim further comprising:
retrieving the information associated with the user from a directory service.

7. The method of claim 6, wherein the information associated with the user includes one or more of presence information and contacts of the user.

8. The method of claim 1, further comprising:
retrieving the information associated with the location from one or more location based services.

9. The method of claim 8, wherein the information associated with the location includes one or more of a geographical location of a person, a place, or an object, and information associated with the person, the place, or the object.

10. The method of claim 1, further comprising:
retrieving the information associated with the one or more active applications from one or more of a calendar application, a communication application, and a storage application associated with the productivity service.

11. The method of claim 10, wherein the information associated with the one or more active applications includes one or more of content of calendar items within the calendar application, content of communication items within the communication application, and content of documents within the storage application.

12. A server configured to implement an intelligent canvas associated with a productivity service to provide suggestions for task completion, the server comprising:
a communication interface configured to facilitate communication between the server and one or more client devices;
a memory configured to store instructions; and
one or more processors coupled to the communication interface and the memory, the one or more processors configured to:
receive content input on the intelligent canvas through the communication interface;
determine a context for the content input based on information associated with one or more of a user, a time, a location, and one or more active applications;
perform an inference for a suggestion to complete a task associated with the content input based on the determined context and the content input; and
implement the suggestion to complete the task.

13. The server of claim 12, wherein the one or more processors are further configured to receive the content input through one or more input devices communicatively coupled to the one or more client devices.

14. The server of claim 13, wherein the one or more input devices allow one or more of: a keyboard input, a mouse input, a pen input, a touch input, an optical capture, a voice input, a gyroscopic input, and an eye-tracking input.

15. The server of claim 14, wherein the one or more processors are further configured to employ one or more natural language processing techniques based on a type of the input received.

16. The server of claim 12, wherein the intelligent canvas is one of:
an integral module of a task management application associated with the productivity service;
an integral module of one or more of a calendar application, a communication application, and a storage application associated with the productivity service; and
an integral module of a separate task management service configured to serve the productivity service.

17. A system configured to implement an intelligent canvas associated with a productivity service to provide suggestions for task completion, the system comprising:
a first server configured to host the productivity service;
a second server configured to host a task management service configured to serve the productivity service, wherein the intelligent canvas is an integral module of the task management service, the second server comprising;
a communication interface configured to facilitate communication between the first server and the second server;
a memory configured to store instructions; and
one or more processors coupled to the communication interface and the memory, the one or more processors configured to:
receive content input on the intelligent canvas;
determine a context for the content input based on information associated with one or more of a user, a time, a location, and one or more active applications;
perform an inference for a suggestion to complete a task associated with the content input based on the determined context and the content input; and
implement the suggestion to complete the task in conjunction with one or more applications associated with the productivity service.

18. The system of claim 17, wherein the suggestion to complete the task is implemented based on a type of item the task is associated with.

19. The system of claim 18, wherein the task is associated with one or more of a calendar item, a communication item, a document, and a location item.

20. The system of claim 17, wherein the one or more applications associated with the productivity service include one or more of a calendar application, a communication application, a storage application, a word-processing application, a presentation application, a notebook application, and a spreadsheet application.
